(19) United States
(12) Patent Application Publication
(10) Pub. No.: US 2024/0151872 A1
(43) Pub. Date: May 9, 2024

(54) SIGNAL ACQUISITION METHOD AND DEVICE OF AZIMUTHAL ELECTROMAGNETIC WAVE RESISTIVITY INSTRUMENT WHILE DRILLING

(71) Applicant: Institute of Geology and Geophysics, Chinese Academy of Sciences, Beijing (CN)

(72) Inventors: Yali ZHANG, Beijing (CN); Wenxiu ZHANG, Beijing (CN); Wenxuan CHEN, Houston, TX (US)

(21) Appl. No.: 18/453,696

(22) Filed: Aug. 22, 2023

(30) Foreign Application Priority Data
Nov. 4, 2022 (CN) 202211380425.0

(51) Int. Cl. G01V 3/28; E21B 47/024

(52) U.S. Cl. CPC G01V 3/28; E21B 47/024

(57) ABSTRACT

The present invention provides a signal acquisition method and device of an azimuthal electromagnetic wave resistivity instrument while drilling. The method comprises: step 1. picking up, by a receiving antenna, a magnetic induction signal after formation attenuation, and converting the received magnetic induction signal into an electrical signal for subsequent circuit processing; step 2. amplifying, by a preamplifier circuit, the fixed gain of a weak signal with nV level amplitude induced on the receiving antenna; step 3. controlling a filtering circuit through a controller, and filtering the amplified signal, wherein the filtering circuit comprises an analog switch and two low pass filters with different frequencies, and for receiving signals with different frequencies, a field programmable gate array (FPGA) controller achieves the selection of the filtering frequency by controlling on/off of the analog switch; step 4. amplifying the filtered signal using a programmable amplifier circuit; and step 5. conducting digital conversion for the measured signal that meets the requirements by means of low-frequency acquisition by the analog-to-digital conversion circuit under the control of the FPGA.

### TECHNICAL FIELD

The present invention relates to the technical field of oil and gas geological exploration and measurement, in particular to a signal acquisition method and device of an azimuthal electromagnetic wave resistivity instrument while drilling.

### BACKGROUND ART

As the conventional oil and gas exploration and development enters the middle and late stage, more and more complex oil and gas resources need to be developed by high-angle wells or horizontal wells to improve yield and benefits, wherein the logging while drilling technology is an indispensable important means of oil and gas exploration and development of the high-angle wells and horizontal wells, is mainly used for geological guidance and formation evaluation, and becomes one of the irreplaceable technologies in the current petroleum exploration and development. This technology obtains formation evaluation information such as lithology, saturation and porosity during drilling, provides drilling engineering parameters for effective drilling of reservoirs, and carries out logging work under harsh borehole conditions, and thus has advantages in many aspects.

As one of the important instruments for geological guidance and formation evaluation, the azimuthal electromagnetic wave resistivity instrument while drilling has a basic working principle that one or more axial transmitting antennas are used to transmit electromagnetic wave signals of different frequencies to the earth. The electromagnetic wave signals propagate along the direction of borehole and around the borehole respectively. Due to different absorption effects of different resistivity formations on electromagnetic waves, the electromagnetic wave signals propagated and attenuated along the direction of borehole may carry formation parameter information. By measuring the amplitude ratio and the phase difference of a plurality of axial receiving antennas at different distances from the transmitting antennas, the formation resistivity parameters can be obtained through inversion to evaluate the oiliness of the formation. At the same time, when the electromagnetic wave signals propagating around the borehole encounter a formation boundary, the signals are reflected through the formation boundary and received by horizontal or oblique antennas which have an angle with the axial direction. Combined with the azimuth information of the instrument, the distance and the direction of the formation boundary relative to the instrument can be accurately judged, so as to adjust a trajectory and carry out geological guidance.

The azimuthal electromagnetic wave resistivity instrument while drilling generally uses high transmission frequencies from a few hundred kHz to a few MHz, such as 400 kHz or 2 MHz.

According to Nyquist sampling theorem, the sampling frequency of an analog-digital converter (ADC) should not be less than twice of the highest frequency of the measured signal in order to recover the measured signal without distortion. At the same time, in order to ensure the accuracy of acquisition, the actual sampling frequency is generally much higher than twice of the highest frequency of the measured signal.

The traditional high frequency signal acquisition method generally adopts superheterodyne frequency-mixing mode or selects an ADC chip with high sampling rate. The superheterodyne frequency-mixing mode is to mix the frequencies of the measured signal and a local oscillating signal to obtain a high frequency signal and an intermediate frequency signal at two frequencies, and then select the intermediate frequency signal through band-pass filtering, so as to realize down frequency conversion processing of the high frequency measured signal. The frequency of the intermediate frequency signal is less than ½ of the maximum sampling rate of the ADC selected by the instrument, which satisfies the Nyquist sampling theorem and can retain the amplitude and phase information of the measured signal, thereby ensuring the measurement accuracy of the high frequency measured signal. An ADC chip with a sampling rate more than twice of the measured frequency can directly sample the amplified and filtered measured signal, and the sampled signal can be stored or processed by a subsequent digital circuit.

When the azimuthal electromagnetic wave resistivity instrument while drilling detects the formation boundary, the signal is very weak, usually in the nV level, so higher requirements are proposed for a signal conditioning circuit and an acquisition circuit. When the above superheterodyne frequency-mixing mode is used for down frequency conversion processing of the measured signal, a frequency mixer and a filtering hardware circuit will be introduced into the acquisition circuit, which will introduce complex system noise, reduce the signal-to-noise ratio of the signal and increase the power consumption of the instrument. However, the ADC chip with high sampling rate can meet the sampling requirements of the high frequency signal, but have certain disadvantages in cost and accuracy. The ADC chips of the same accuracy level are generally more expensive with higher sampling rate. Higher sampling rate brings more data and also increases the cost of the whole system. Moreover, speed and accuracy of the ADC are often contradictory, so blindly pursuing high sampling rate may inevitably lose measurement accuracy.

### SUMMARY OF THE INVENTION

The purpose of the present invention is to provide an acquisition method and device of receiving signals of an azimuthal electromagnetic wave resistivity instrument while drilling, so as to realize the sampling of high frequency signals at a low sampling frequency, improve the signal-to-noise ratio of the measured signal, improve the detection ability of the azimuthal electromagnetic wave resistivity instrument while drilling for high frequency weak signals, and reduce the power consumption of the instrument.

The technical solution of the present invention is: a low frequency acquisition method of an azimuthal electromagnetic wave resistivity instrument while drilling comprises:
step 1. picking up, by a receiving antenna, a magnetic induction signal after formation attenuation, and converting the received magnetic induction signal into an electrical signal for subsequent circuit processing;
step 2. amplifying, by a preamplifier circuit, the fixed gain of a weak signal with nV level amplitude induced on the receiving antenna; and using, by the preamplifier circuit, a three-operational amplifier instrument amplifier to realize high input impedance and eliminate common mode interference;
step 3. controlling a filtering circuit through a controller, and filtering the amplified signal, wherein the filtering circuit comprises an analog switch and two low pass filters with different frequencies, and for receiving signals with different frequencies, an FPGA controller achieves the selection of the filtering frequency by controlling on/off of the analog switch;
step 4. amplifying the filtered signal using a programmable amplifier circuit, wherein the programmable amplifier circuit comprises a multiplexer and an amplifier, and an FPGA realizes the control of the feedback resistance of the amplifier by controlling the multiplexer, to realize a gain-adjustable amplifier circuit and meet the sampling requirements of an analog-digital converter circuit; and
step 5. conducting digital conversion for the measured signal that meets the requirements by means of low-frequency acquisition by the analog-to-digital conversion circuit under the control of the FPGA.

According to another aspect of the present invention, a signal acquisition device of an azimuthal electromagnetic wave resistivity instrument while drilling is provided, which comprises a receiving antenna, a preamplifier circuit, a filtering circuit, a programmable amplifier circuit, an analog-to-digital conversion circuit and a controller.

The preamplifier circuit adopts a three-operational amplifier instrument amplifier, and the structure has high input impedance, and inhibits common mode interference;
The controller uses the FPGA to realize the flexible control of the filtering circuit, the programmable amplifier circuit and the analog-to-digital conversion circuit;
The filtering circuit has a dual-frequency selection function, and the filtering frequency is selected through the control of the analog switch by the FPGA.

The programmable amplifier circuit is controlled by the FPGA, and the feedback resistance of the connected amplifier is controlled by the multiplexer to achieve the purpose of programmable gain.

The analog-to-digital conversion circuit uses a low frequency acquisition technology to detect the amplitude and the phase of high frequency signals.

The low frequency acquisition satisfies the condition: qfₛ=pf₀, where p and q are integers not less than 2, and q>p. The recovery of signals to be sampled is realized by selecting the appropriate p and q.

### Beneficial Effects

The existing azimuthal electromagnetic wave resistivity instrument while drilling is limited by the highest sampling frequency of the ADC, and generally adopts the superheterodyne mode to conduct down frequency conversion processing for the signals of a receiving coil, and then samples the signals after obtaining the low and medium frequency signals, or selects the ADC chip with high sampling rate to realize the recovery of the measured signal. The superheterodyne mode increases complexity and power consumption of the circuit, and introduces extra noise. The ADC chip with high sampling rate increases the sampling cost and loses the sampling accuracy. The low frequency acquisition technology of the present invention can avoid the above disadvantages, and recover the amplitude and the phase of the measured signal at a low sampling rate, which not only can reduce the requirements on the sampling rate of the ADC chip, but also can simplify the circuit structure, improve the signal-to-noise ratio level of the instrument and reduce the power consumption of the instrument.

### BRIEF DESCRIPTION OF THE DRAWINGS

FIG. 1 shows an acquisition and processing process of a receiving signal of an azimuthal electromagnetic wave resistivity instrument while drilling;

FIG. 2 is a schematic diagram of a low frequency acquisition technology; and

FIG. 3 shows a recovered signal obtained after low frequency acquisition.

### DETAILED DESCRIPTION OF THE INVENTION

Technical solutions in embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

According to embodiments of the present invention, the present invention discloses a signal acquisition method of an azimuthal electromagnetic wave resistivity instrument while drilling, which is used for collecting high frequency weak signals.

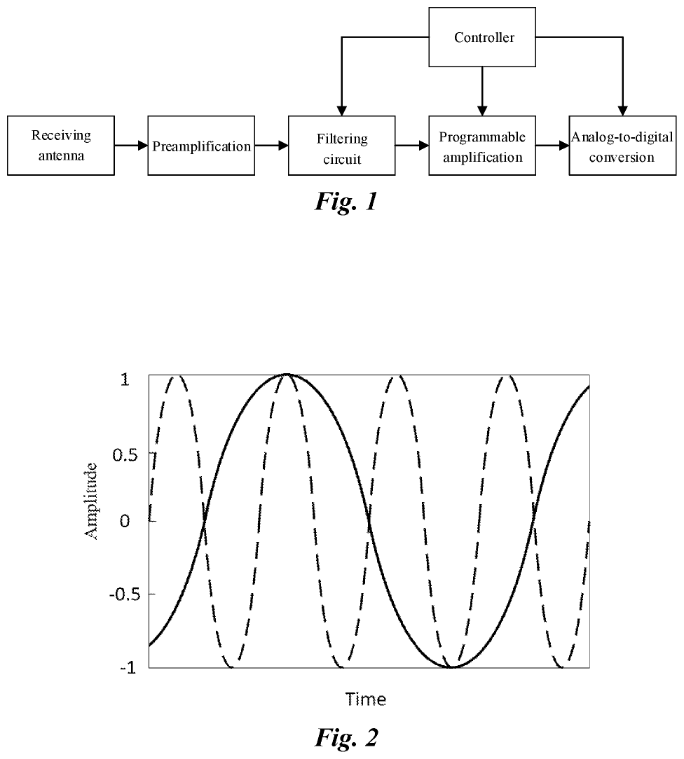

As shown in FIG. 1, a signal acquisition circuit of the azimuthal electromagnetic wave resistivity instrument while drilling comprises a receiving antenna, a preamplifier circuit, a filtering circuit, a programmable amplifier circuit, an analog-to-digital conversion circuit and a controller, wherein a processing and acquisition process of a magnetic field signal in any channel is shown in FIG. 1: The receiving antenna is used for picking up a magnetic induction signal after formation attenuation or boundary reflection, and converting the received magnetic induction signal into an electrical signal for subsequent circuit processing.

The preamplifier circuit amplifies the fixed gain of a weak signal with nV level amplitude induced on the receiving antenna using a three-operational amplifier instrument amplifier, and this circuit structure can realize high input impedance, eliminate common mode interference and amplify the weak signal on the receiving antenna with very small error.

The controller uses a field programmable gate array (FPGA) to realize the sequential control of the filtering circuit, the programmable amplifier circuit and the analog-to-digital conversion circuit.

The filtering circuit comprises an analog switch and two low pass filters with different frequencies, and for receiving signals with different frequencies, an FPGA controller achieves the selection of the filtering frequency by controlling on/off of the analog switch.

The programmable amplifier circuit comprises a multiplexer and an amplifier, and an FPGA realizes the control of the feedback resistance of the amplifier by controlling the multiplexer, to realize a gain-adjustable amplifier circuit and meet the sampling requirements of an analog-digital converter circuit.

The analog-to-digital conversion circuit conducts digital conversion for the measured high frequency signal that meets the requirements by means of low-frequency acquisition under the control of the FPGA.

According to the embodiments of the present invention, the low frequency acquisition method refers to an acquisition technology of recovering the amplitude and the phase of the measured signal without distortion by selecting a sampling frequency lower than the Nyquist sampling rate. The relationship between sampling frequency fₛ adopted by the low frequency acquisition method and the frequency f₀ of the measured signal satisfies: qfₛ=pf₀, where p and q are positive integers not less than 2, and q>p;
A method of restoring the amplitude A and phase φ of the measured signal using the low frequency acquisition technology comprises the following steps:
a. Designing the sampling frequency fₛ according to the frequency f₀ of the measured signal, wherein the fₛ shall satisfy qfₛ=pf₀, p and q are integers not less than 2, and q>p;
Specifically, the sampling frequency fₛ and the target signal frequency fₓ which can recover the amplitude and the phase without distortion satisfy

$${f}_{x} = {f}_{0} - {nf}_{s} = \frac{a}{p} {f}_{s} ;$$

n is the largest integer of

$$\frac{q}{p} , \frac{q}{p} = n + \frac{a}{p} ,$$

and a is a positive integer less than p.
b. Sampling the measured signal within a target signal period Tₓ using the sampling frequency fₛ to obtain a discrete sequence x[k], wherein k is a kth sampling point within corresponding sampling time and k is an integer between 0 and p−1;
Specifically, the period

$${T}_{x} = \frac{1}{{f}_{x}} ,$$

and fₓ is the target signal frequency of the recovered signal after low frequency acquisition.
c. Transmitting the discrete sequence x[k] obtained from low frequency acquisition to the FPGA controller for storage and processing by a subsequent digital circuit.

The low frequency acquisition technology realizes the digital processing of high frequency signals without the use of the ADC chip with high sampling rate, saves sampling cost, does not need complex hardware circuit, and improves the signal-to-noise ratio level.

In this design, with an example that the receiving antenna receives weak signals with frequencies of 400 kHz and 2 MHz, a technical solution of low frequency acquisition provided in this patent is further elaborated.

The specific working principle of the low frequency acquisition technology is shown in FIG. 2. In the figure, a dashed line signal is a measured high frequency signal, and a solid line signal is a low frequency acquisition recovered signal. The solid line signal can recover the amplitude and the phase of the measured signal without distortion. After low frequency acquisition, the amplitude and the phase can be recovered by calculation.

In the low frequency acquisition technology, the determination of the sampling frequency is the key of the present invention. If the amplitude and the phase of the measured signal are restored without distortion, one of the basic conditions of the low frequency acquisition technology needs to be satisfied: qfₛ=pf₀. Where p and q are integers not less than 2 and q>p; f₀ is the frequency of the measured signal, and fₛ is the sampling frequency
f₀>nfₛ is set; fₓ=f₀−nfₛ; n is a largest integer value not greater than

$$\frac{q}{p} , \frac{q}{p} = n + \frac{a}{p} ,$$

and a is a positive integer less than p. This can obtain:

$${f}_{x} = {f}_{0} - {nf}_{s} = \frac{a}{p} {f}_{s}$$

fₓ is a target signal frequency of low frequency acquisition results, and fₛ is a low frequency sampling frequency.

A measured analog signal can be expressed as:

S(t)=Acos(2πf₀t+<φ)

A, f₀ and φ are the amplitude, the frequency and the phase of the measured signal respectively. If the sampling frequency of fₛ is used for sampling, a discretized digital signal can be obtained:

$$S ( k ) = Acos ( 2 π ( n + \frac{a}{p} ) {f}_{s} \times \frac{k}{{f}_{s}} + φ ) = Acos ( \frac{2 π ak}{p} + φ )$$

In this design, the recovered signal with the target frequency of fₓ is sampled at 8 points per cycle, that is, p=8. The p and q values of the measured signal at 400 kHz and 2 MHz can be calculated according to the basic conditions of low frequency acquisition. However, it should be noted that the calculated p and q values may not be unique for the low frequency acquisition technology at a fixed frequency. In order to facilitate the control of the ADC chip by the FPGA controller and avoid the frequent switching of the analog-to-digital conversion circuit caused by the sampling frequency fₛ corresponding to the measured signals of different frequencies, the same sampling frequency fₛ is used here for low frequency acquisition of the measured signals of 400 kHz and 2 MHz respectively, and fₛ=128 kHz is taken uniformly. Therefore, on the premise that the sampling frequency is determined, q value corresponding to 400 kHz signal can be 25 and q value corresponding to 2 MHz signal can be 125 through a large amount of data analysis. Through further calculation, a value corresponding to 400 kHz signal is 1 and a value corresponding to 2 MHz signal is 5, i.e.:
f₀=400 kHz, fₛ=128 kHz, p=8, q=25, a=1, fₛ=128 kHz, fₓ=16 kHz;
f₀=2 MHz, f=128 kHz, p=8, q=125, a=5, fₛ=128 kHz, fₓ=80 kHz.

After the p and a values are determined, the discretized digital signal S(k) is further analyzed.

$$When p = 8 and a = 1 , {S}_{1} ( k ) = Acos ( \frac{π k}{4} + φ ) ;$$

$$When p = 8 and a = 5 , {S}_{5} ( k ) = Acos ( k π + \frac{π k}{4} + φ ) = {( 1 - 1 )}^{k} Acos ( \frac{π k}{4} + φ ) .$$

S₁(k) represents S(k) when a value is 1 and p value is 8, and S₅(k) represents S(k) when a value is 5 and p value is 8. By comparing S₁(k) with S₅(k), S₁ and S₅ are recovered signals. It can be found that S₁(k)=(−1)^{k}S₅(k), that is, when a=5, a target signal with the same frequency as that when a=1 can be recovered by inverting symbol bits of the sampling points in odd positions. The discrete target signal retains the amplitude and the phase of the measured analog signal S(t). Therefore, for the measured signal of 2 MHz, the symbol bits of the sampling points in the odd positions are inverted in this design, to convert the target signal frequency from 80 kHz to 16 kHz, which is the same as the target frequency of 400 kHz. In this way, the ADC chip can be configured to digitize two measured signals at the same sampling frequency, thereby avoiding the frequent control of the FPGA controller on the analog-to-digital conversion circuit and simplifying the complexity of codes.

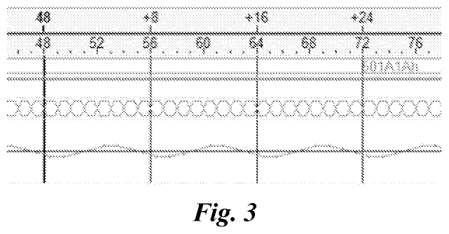

According to the above analysis, a sampling clock of 128 kHz is arranged inside the FPGA controller, and is used to configure an analog-to-digital conversion module to realize the low frequency acquisition of the measured analog signals of 400 kHz and 2 MHz. The discrete data after low frequency acquisition is processed and calculated by the FPGA. FIG. 3 below shows recovered signals obtained by a logic analyzer in the FPGA. The sampling frequency set by the logic analyzer is 128 kHz, and there are 8 sampling points between every two time bars. The target signal with a frequency of 16 kHz can be recovered from FIG. 3, thereby realizing the low frequency acquisition of the high frequency signals.

Illustrative specific embodiments of the present invention are described above to facilitate those skilled in the art to understand the present invention. However, it should be understood that the present invention is not limited to the scope of the specific embodiments. For those ordinary skilled in the art, as long as various changes are within the spirit and scope of the present invention defined and determined by the attached claims, these changes are obvious. All inventions which utilize the conception of the present invention are protected.

1. A signal acquisition method of an azimuthal electromagnetic wave resistivity instrument while drilling, characterized by comprising:
step 1. picking up, by a receiving antenna, a magnetic induction signal after formation attenuation, and converting the received magnetic induction signal into an electrical signal for subsequent circuit processing;
step 2. amplifying, by a preamplifier circuit, the fixed gain of a weak signal with nV level amplitude induced on the receiving antenna; and using, by the preamplifier circuit, a three-operational amplifier instrument amplifier to realize high input impedance and eliminate common mode interference;
step 3. controlling a filtering circuit through a controller, and filtering the amplified signal, wherein the filtering circuit comprises an analog switch and two low pass filters with different frequencies, and for receiving signals with different frequencies, a field programmable gate array (FPGA) controller achieves the selection of the filtering frequency by controlling on/off of the analog switch;
step 4. amplifying the filtered signal using a programmable amplifier circuit, wherein the programmable amplifier circuit comprises a multiplexer and an amplifier, and an FPGA realizes the control of the feedback resistance of the amplifier by controlling the multiplexer, to realize a gain-adjustable amplifier circuit and meet the sampling requirements of an analog-digital converter circuit; and
step 5. conducting digital conversion for the measured signal that meets the requirements by means of low-frequency acquisition by the analog-to-digital conversion circuit under the control of the FPGA,
wherein the low frequency acquisition includes:
(1) designing a low frequency sampling frequency fs according to the frequency f0 of a measured high frequency signal, wherein fₛ needs to satisfy qf_s=pf_0, p and q are integers not less than 2, and q>p;
(2) sampling the measured signal within a target signal period T_x using the sampling frequency fs to obtain a discrete sequence x[k], wherein k is a kth sampling point within corresponding sampling time and k is an inter between 0 and p−1; the period T_x=1/f_x, and f_x is the target signal frequency of a recovered signal after low frequency acquisition; and
(3) transmitting the discrete sequence x[k] obtained from low frequency acquisition to an FPGA controller for storage and processing by a subsequent digital circuit.

2. (canceled)

3. The signal acquisition method of the azimuthal electromagnetic wave resistivity instrument while drilling according to claim 1, characterized in that a method of calculating amplitude A and phase φ of the measured signal using the low frequency acquisition method comprises the following steps:
(1) determining p, q and a values according to the low frequency sampling frequency fₛ:
f₀>nfₛ is set; fₓ=f₀−nfₛ; n is a largest integer value not greater than
$$\frac{q}{p} , \frac{q}{p} = n + \frac{a}{p} ,$$
and a is a positive integer less than p; this obtains:
$${f}_{x} = {f}_{0} - {nf}_{s} = \frac{a}{p} {f}_{s} ;$$
a measured analog signal is expressed as: S(t)=Acos(2πf₀t+φ);
(2) A, f₀ and φ are the amplitude, the frequency and the phase of the measured signal respectively; and if the sampling frequency of fₛ is used for sampling, a discretized digital signal is obtained:
$$S ( k ) = Acos ( 2 π ( n + \frac{a}{p} ) {f}_{s} \times \frac{k}{{f}_{s}} + φ ) = Acos ( \frac{2 π ak}{p} + φ )$$
(3) analyzing the characteristics of the discretized digital signal S(k) according to the determined p and a values; and
(4) calculating the amplitude A and the phase φ of a target signal.

4. (canceled)
